(19) United States
(12) Patent Application Publication
(10) Pub. No.: US 2017/0337909 A1
(43) Pub. Date: Nov. 23, 2017

(54) SYSTEM, APPARATUS, AND METHOD THEREOF FOR GENERATING SOUNDS

(71) Applicant: Mark K. Sullivan, Houston, TX (US)

(72) Inventor: Mark K. Sullivan, Houston, TX (US)

(21) Appl. No.: 15/434,055

(22) Filed: Feb. 16, 2017

Related U.S. Application Data
(60) Provisional application No. 62/295,188, filed on Feb. 15, 2016.

(51) Int. Cl. G10H 1/00; G10H 1/32

(52) U.S. Cl. CPC G10H 1/0008; G10H 1/32; G10H 2220/401; G10H 2220/201; G10H 2230/365; G10H 2220/395

(57) ABSTRACT

An electronic musical instrument for generating a plurality of audio signals can include an attitude measuring unit that is configured to measure one or more changes in an attitude of the musical instrument with respect to a reference frame in a multi-dimensional space. The musical instrument can also include a processor that is configured to generate one or more signals based on the measured changes in the attitude of the musical instrument. The musical instrument can also include an audio synthesizer that is configured to generate the plurality of audio signals based on the generated signals.

### CROSS-REFERENCE TO RELATED APPLICATIONS

This application claims the benefit provisional U.S. Patent Application Ser. No. 62/295,188, filed on Feb. 15, 2016, entitled “Musical Instrument and Method of Control thereof using Attitude relative to a Reference Frame” which is incorporated herein by reference.

### BACKGROUND

The disclosed subject matter relates to methods and apparatus for generating sounds. More particularly, the disclosed subject matter relates to systems, apparatus for generating sounds, and methods of generating musical tones and sounds.

A musical instrument is an instrument that is used to make musical sounds. According to the Hornbostel-Sachs system, the musical instruments are categorized into four main categories. The first category includes idiophones that produce sound by vibrating the body of the musical instrument, for example, xylophones or cymbals. The second category includes membranophones that produces sound by the vibration of a stretched membrane. Examples of the membranophones may be, but not restricted to, drums or kazoos. The third category includes chordophones, such as a piano or cello, which produces sound by the vibration of strings attached between fixed points. Next, the fourth category includes aerophones, for example, pipe organ or oboe, which produce sound by vibrating air. Further, the evolution of musical instruments leads to the creation of a fifth category of musical instruments referred to as electrophones that produce sound electrically. Musical Instruments that fall under this category may include, but not restricted to, Chamberlin, Croix Sonore, Electronde, Hammond organ, Novachord, Oramics, Radiodrum, Stylophone, analog and/or digital synthesizer, Telharmonium, Theremin, and the like.

### SUMMARY

Some musical instruments, as discussed above, have used the vibration of strings, membranes, columns of air, or the instrument itself to make the musical sounds and tones. However, manipulation of the musical instruments evolved into a form of art as the evolution of these musical instruments require significant practice to become proficient and a master. A paradigm shift came with the advent of electrophones, or electronic musical instruments. These electronic musical instruments made it easier to produce sounds that could not be produced by mechanical vibrations alone.

Some of the related arts use electronic musical instruments that are controlled by precise movements of fingers of a player playing the electronic musical instrument. For example, a player has to cover holes, press strings against a stop, push buttons or levers, and the like, of an electronic musical instrument for playing music. In another exemplary scenario, a player plays the electronic musical instrument by the direct regulation input power such as the speed of bowing, force of plucking or striking, or the pressure, flow-rate of breath, and the like. However, the movement of the player's fingers or the direct regulation of input power while playing the electronic musical instrument add complexity, and thereby increase difficulty in generating professional quality music.

It may therefore be beneficial to provide a system, apparatus and method for generating sounds and tones, that address at least one of the above issues. For example, it may be beneficial to provide a system for generating audio signals.

It may therefore be beneficial to provide methods and apparatus that address at least one of the above and/or other disadvantages. In particular, it may be beneficial to provide a system, an apparatus, as well as methods for generating audio signals.

It may therefore be beneficial to provide methods and apparatus that address at least one of the above and/or other disadvantages. In particular, it may be beneficial to provide a system, an apparatus, as well as methods for generating audio signals that are easy to use and do not require professional skills for playing an electronic musical instrument.

Some embodiments are therefore directed to an electronic musical instrument for generating a plurality of audio signals. The electronic musical instrument can include an attitude measuring unit that is configured to measure one or more changes in an attitude of the musical instrument with respect to a reference frame in a multi-dimensional space. The electronic musical instrument can also include a processor that is configured to generate one or more signals based on the measured changes in the attitude of the musical instrument. The electronic musical instrument can also include an audio synthesizer that is configured to generate the plurality of audio signals based on the generated signals.

Some other embodiments are directed to a method for generating a plurality of audio signals. The method can include: measuring, by an attitude measuring unit, one or more changes in an attitude of the musical instrument with respect to a reference frame in a multi-dimensional space; generating, by a processor, one or more signals based on the measured changes in the attitude of the musical instrument; and generating, by an audio synthesizer, the plurality of audio signals based on the generated signals.

Yet other embodiments are directed to a system for interfacing with an external sound output unit to generate a plurality of audio signals. The system can include an electronic musical instrument, wherein the musical instrument comprises an attitude measuring unit that is configured to measure one or more changes in an attitude of the musical instrument with respect to a reference frame in a multi-dimensional space. The musical instrument further comprises a processor that is configured to generate one or more signals based on the measured changes in the attitude of the musical instrument. The musical instrument further comprises an audio synthesizer that is configured to generate the plurality of audio signals based on the generated signals, wherein the plurality of audio signals are compliant to the Musical Instrument Digital Interface (MIDI) standard. The system can also include a communication interface that is configured to communicate the plurality of audio signals to the external sound output unit.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a block diagram of an electronic musical instrument in accordance with the disclosed subject matter.

FIG. 2 is a diagram of an exemplary musical unit communicating with other elements of the electronic musical instrument for generating sound in accordance with the disclosed subject matter.

FIG. 3 is a flowchart of a procedure for generating sound in accordance with the disclosed subject matter.

FIG. 4 is a flowchart of another procedure for generating sound in accordance with the disclosed subject matter.

FIG. 5A is an exploded view of the electronic musical instrument in accordance with the disclosed subject matter.

FIG. 5B is a side view of the electronic musical instrument in accordance with the disclosed subject matter.

FIG. 5C is a side view of the electronic musical instrument in accordance with the disclosed subject matter.

FIG. 5D is a side view of the electronic musical instrument in accordance with the disclosed subject matter.

FIGS. 6A-6C are exemplary movements of the electronic musical instrument for generating sound.

FIG. 7 illustrates an exemplary electronic musical instrument in accordance with the disclosed subject matter.

FIG. 8 is a diagram of an exemplary mobile device in accordance with the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

### I. Structure of an Electronic Musical Instrument

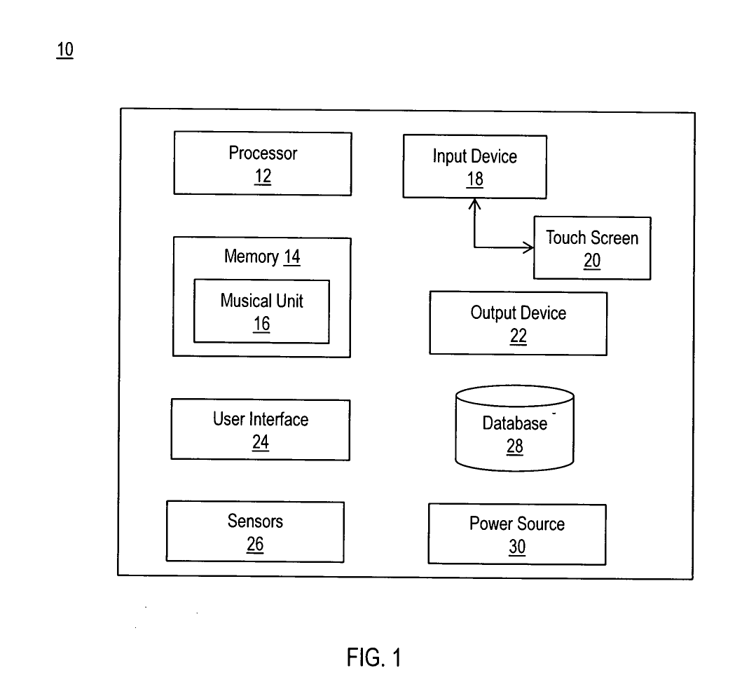

FIG. 1 is a diagram of an electronic musical instrument 10 that may be used to generate sounds.

FIG. 1 illustrates the electronic musical instrument 10 as an electronic device, and embodiments are intended to include or otherwise cover any type of electronic device including, but not restricted to, a musical instrument, a mobile device, a smartphone, a tablet, and the like. In fact, embodiments are intended to include or otherwise cover any type of electronic device, including known, related art, and/or later developed technologies that may be beneficial to produce sounds. In fact, embodiments are intended to include or otherwise cover any type of configurations of the electronic musical instrument 10.

The electronic musical instrument 10 can include a processor 12, a memory 14, a musical unit 16, an input device 18, an output device 22, and the like, to name a few.

In some embodiments, the processor 12 of the electronic musical instrument 10 can be a single core processor. In alternate embodiments, the processor 12 of the electronic musical instrument 10 can be a multi-core processor. Embodiments are intended to include or otherwise cover any type of processor, including known, related art, and/or later developed technologies to enhance capabilities of processing data and/or instructions. The processor 12 can be used to process instructions and/or data stored in the memory 14 of the electronic musical instrument 10. One processor 12 shown in FIG. 1 is for illustration purpose. However, in some alternate embodiments, the electronic musical instrument 10 can include more than one processor 12.

Further, the electronic musical instrument 10 can include the memory 14. The memory 14 can be used to store instructions and/or data that can be processed by the processor 12 of the electronic musical instrument 10. In some embodiments, the memory 14 can be, but not restricted to, a Random Access Memory (RAM), a Read Only Memory (ROM), and the like. Embodiments are intended to include or otherwise cover any type of memory, including known, related art, and/or later developed technologies to enhance capabilities of storing data and/or instructions. One memory 14 shown in FIG. 1 is for illustration purpose. However, in some alternate embodiments, the electronic musical instrument 10 can include more than one memory 14.

In some embodiments, the memory 14 can also include an operating system (not shown) for the electronic musical instrument 10. The memory 14 may also include data such as a player's preferences for the electronic musical instrument 10. In some alternate embodiments, the memory 14 may also include historical and/or pre-stored tones and sounds played by one or more players using the electronic musical instrument 10.

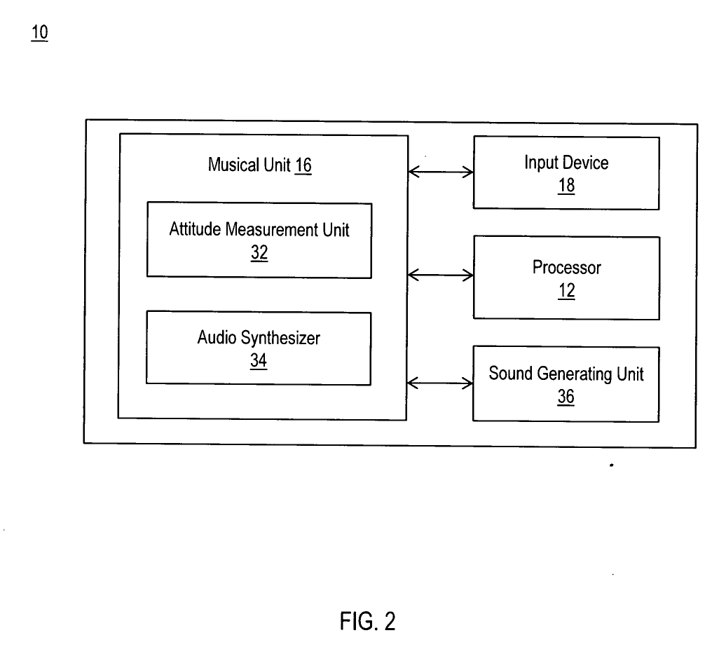

In some embodiments, the memory 14 can include a musical unit 16 that may be used to generate sounds. In some alternate embodiments, the musical unit 16 can be an application stored in the memory 14 of the electronic musical instrument 10. In some embodiments, the memory 14 may store programs such as, but not restricted to, tables of values, for example, musical scales; waveform tables for the synthesizer, settings related to the electronic musical instrument 10, and the like. The functioning of the musical unit 16 is described in detail below in conjunction with FIG. 2.

The electronic musical instrument 10 can include an input device 18 that can be configured to receive inputs from a user of the electronic musical instrument 10. A user can be, but not restricted to, a player, an entertainer, an artist, and the like, which uses the electronic musical instrument 10 to generate sounds.

The input device 16 can include, but not restricted to, a touch screen 20, a stylus (not shown), and the like. In certain embodiments, the user inputs can be received by using a stylus that enables the user (hereinafter, interchangeably referred to as a player) to provide inputs to the electronic musical instrument 10. Further, the electronic musical instrument 10 can include a touch screen 20 that can be used to receive the user inputs by the touch of the player. For example, the player can touch the screen 20 of the electronic musical instrument 10 to provide inputs such as, but not restricted to, a musical scale, a name of the player, a mode of the electronic musical instrument 10, and the like. The input device 16 can also include other devices such as, Universal Serial Bus (USB) receptacle (not shown), a microphone (not shown), a camera (not shown), and the like. Embodiments are intended to include or otherwise cover any type of input device, including known, related art, and/or later developed technologies to enhance capabilities of receiving user inputs.

In some embodiments, the electronic musical instrument 10 can include an output device 22, such as speakers, headphones, or earphones, etc. In an exemplary scenario, the USB receptacle can be used to connect headphones with the electronic musical instrument 10. Embodiments are intended to include or otherwise cover any type of output device, including known, related art, and/or later developed technologies.

The electronic musical instrument 10 may also include a user interface 24 for communicating with the player of the electronic musical instrument 10. In some embodiments, the touch screen 20 can be the user interface 24 of the electronic musical instrument 10. In some alternate embodiments, the touch screen 20 can be different from the user interface 24 of the electronic musical instrument 10. Embodiments are intended to include or otherwise cover any type of user interface 24, including known, related art, and/or later developed technologies that can be beneficial to communicate with the player of the electronic musical instrument 10. In some embodiments, the user interface 24 may work in conjunction with the input device 18 to receive the user inputs.

Further, the electronic musical instrument 10 may include sensors 26 for determining and/or measuring motion of the electronic musical instrument 10. In some embodiments, the sensors 26 can be motion sensors in order to measure, a pitch, a roll, and/or a yaw of the electronic musical instrument 10. In some alternate embodiments, the sensors 26 can include or otherwise cover any type of sensors, including known, related art, and/or later developed technologies. In some embodiments, the sensors 26 can be, but not restricted to, accelerometers, gyroscopes, magnetometers, and the like. The accelerometers are used to detect static and/or dynamic acceleration of the electronic musical instrument 10 when the electronic musical instrument 10 moves in left or right, up or down, clockwise or anti-clockwise direction in a multi-dimensional space. The gyroscope may measure the rotational motion of the electronic musical instrument 10. The magnetometers are used to detect the magnetic field of the electronic musical instrument 10.

The sensors 26 can be used to determine a change in the attitude of the electronic musical instrument 10. The attitude of the electronic musical instrument 10 can include, but not restricted to, a motion, an angle, a direction, a pitch, a roll, a yaw, and the like. In some embodiments, the sensors 26 of the electronic musical instrument 10 can be used to determine a change in the attitude of the electronic musical instrument 10 relative to the gravitational, inertial, and/or geomagnetic reference frame.

Further, the determined attitude of the electronic musical instrument 10 and the player's preferences are processed by the processor 12 in order to generate signals. In some embodiments, the determined attitude of the electronic musical instrument 10 and the player's preferences are processed by mathematical algorithms running on a general purpose microcontroller and/or a processor such as, the processor 12 of the electronic musical instrument 10.

In some embodiments, the signals can be used to control musical parameters of the electronic musical instrument 10. The musical parameters of the electronic musical instrument 10 can be, but not restricted to, a pitch, an amplitude, a timbre, a vibrato, a tremolo, and the like.

In some embodiments, the electronic musical instrument 10 can include a database 28 for storing the measured attitude of the electronic musical instrument 10. In some alternate embodiments, the database 28 of the electronic musical instrument 10 may be used to store the player's preferences, such as, but not restricted to, the musical scale, a mode of the electronic musical instrument 10, a player's profile (for example, a name and age) musical notes, musical tones, and the like. Embodiments are intended to include or otherwise cover any type of database, including known, related art, and/or later developed technologies to enhance capabilities of storing data and/or instructions. One database 28 shown in FIG. 1 is for illustration purpose. However, some alternate embodiments of the disclosed subject matter can include more than one database 28 in the electronic musical instrument 10.

The electronic musical instrument 10 may also include a power source 30 for providing electronic power to the components of the electronic musical instrument 10. In some embodiments, the power source 30 may be situated internal to the electronic musical instrument 10. In some alternate embodiments, the power source 30 may be connected externally to the electronic musical instrument 10. Embodiments are intended to include or otherwise cover any type of power source, including known, related art, and/or later developed technologies to enhance capabilities of providing power to the electronic musical instrument 10. One power source 30 shown in FIG. 1 is for illustration purpose. However, some alternate embodiments of the disclosed subject matter can include more than one power source 30 in the electronic musical instrument 10.

The electronic musical instrument 10 can include a system bus (not shown) to connect components of the electronic musical instrument 10 as discussed in detail above. The system bus can include several types of bus structures including a memory bus, or a memory controller, a peripheral bus, or a local bus using any of a variety of bus architectures. A Basic Input/Output System (BIOS) stored in the memory 14, such as Read Only Memory (ROM), can provide a basic routine that helps to transfer information between the components within the electronic musical instrument 10, during start-up.

### II. Functioning of the Electronic Musical Instrument

FIG. 2 is a diagram of an exemplary musical unit 16 communicating with other elements of the electronic musical instrument 10 for generating sounds in accordance with the disclosed subject matter.

In some embodiments, the musical unit 16 of the electronic musical instrument 10 can include, but not restricted to, an attitude measurement unit 32, and an audio synthesizer 34. One attitude measurement unit 32 and one audio synthesizer 34 is shown for illustration purpose. However, in some alternate embodiments, the musical unit 16 can include more than one attitude measurement unit 32 and the audio synthesizer 34.

In some embodiments, a player can hold the electronic musical instrument 10 in a hand and move the wrist, elbow and shoulder in order to move the electronic musical instrument 10. A player of the electronic musical instrument 10 can be, but not restricted to, a user, a performer, an artist, an entertainer, and the like. The player is free to move the wrist, elbow and shoulder in the multi-dimensional space. The player can hold the electronic musical instrument 10 either in left hand, or in right hand and based on the motion of the electronic musical instrument 10, the attitude of the electronic musical instrument 10 changes.

In some embodiments, the attitude measurement unit 32 can be configured to measure an attitude of the electronic musical instrument 10, one or more changes in the attitude of the electronic musical instrument 10, and/or a rate of change in attitude of the electronic musical instrument 10. The attitude of the electronic musical instrument 10 can be, but not restricted to, a motion, an angle, a direction, a pitch, a roll, a yaw, and the like. The motion of the electronic musical instrument 10 can be defined in terms of, but not restricted to, displacement, distance, velocity, acceleration, time and speed. In some embodiments, the change in attitude of the electronic musical instrument 10 can be measured by using motion sensors. Examples of the motion sensors can include, but not restricted to, accelerometers, gyroscopes, magnetometers, and the like. The accelerometers are used to measure static and/or dynamic acceleration of the electronic musical instrument 10. The gyroscopes are used to measure rotational motion of the electronic musical instrument 10. The magnetometers are used to measure the magnetic field of the Earth, relative to the electronic musical instrument 10, or to determine the orientation of the electronic musical instrument 10 relative to the Earth. Embodiments are intended to include or otherwise cover any type of motion sensors, including known, related art, and/or later developed technologies to measure a change and/or a rate of change in attitude of the electronic musical instrument 10. In fact, embodiments are intended to include or otherwise cover any type of sensors, including known, related art, and/or later developed technologies to measure the attitude and/or a change in attitude of the electronic musical instrument 10.

In some embodiments, the attitude measurement unit 32 can be configured to measure the change in attitude of the electronic musical instrument 10 with respect to a reference frame in a multi-dimensional space. The reference frame can be, but not restricted to, a gravitational reference frame, an inertial reference frame, or a geomagnetic reference frame. The reference frame in a multi-dimensional space can be used to set a physical reference point to uniquely fix a coordinate system and to make the measurements relative to the coordinate system. The multi-dimensional space may be, but not restricted to, a Cartesian coordinate system, i.e., a three dimensional space that can include, a x-coordinate, a y-coordinate, and a z-coordinate. For example, the accelerometers measure static and/or dynamic acceleration of the electronic musical instrument 10 along a spatial axis. The gyroscopes measure rotational motion around a spatial axis of the electronic musical instrument 10. The magnetometers measure the magnetic field along a spatial axis of the electronic musical instrument 10.

Further, as discussed, the input device 18 can be configured to receive inputs from the player playing with the electronic musical instrument 10. The inputs can include the player's preferences such as, but not restricted to, a musical scale, a name, a change in attitude mode, a rate of change in attitude mode, and the like. In some embodiments, the player may provide the inputs by using the touch screen 20 of the electronic musical instrument 10. In some embodiments, the electronic musical instrument 10 may enable the player to select either a change in attitude mode, or a rate of change in attitude mode for the operation of the electronic musical instrument 10.

Next, the processor 12 of the electronic musical instrument 10 can be configured to process the player's preferences and the measured change in attitude of the electronic musical instrument 10. In some embodiments, the processor 12 can then generate signals based on the player's preferences and the measured change in attitude of the electronic musical instrument 10. The generated signals can then be used to control musical parameters of the electronic musical instrument 10. Examples of the musical parameters can include, but not restricted to, a pitch, an amplitude, a timbre, a vibrato, a tremolo, and the like.

In an exemplary scenario, based on the player's preferences, either attitude angles or the rate of change of attitude angles may be used to control a pitch, an amplitude, and other musical parameters such as timbre, vibrato, tremolo, etc. In an exemplary scenario, the processor 12 uses the attitude pitch angle to control the musical pitch and the attitude roll angle to control the amplitude of musical tone. Some player may prefer using the rate of change of roll angle to control the amplitude of the electronic musical instrument 10.

In some alternate embodiments, the processor 12 can quantize the musical pitch to the nearest musical note selected from a musical scale by the player of the electronic musical instrument 10. The musical scale can be a set of musical notes ordered by a fundamental frequency or pitch. The musical scale can be, but not restricted to, complete twelve-tone chromatic scale or could be a specific eight-tone scale such as “C major,” a five-tone “Pentatonic” scale, or any other musical scale.

In some embodiments, the audio synthesizer 34 can be configured to generate electrical audio signals. The audio synthesizer 34 can generate electrical audio signals based on the signals generated by the processor 12. In some embodiments, the audio synthesizer 34 can be configured to generate the oscillating audio signals based on the controlled musical parameters. One audio synthesizer 34 shown in FIG. 2 is for illustration purpose. However, in some alternate embodiments, the musical unit 16 can include more than one audio synthesizer 34. Embodiments are intended to include or otherwise cover any type of audio synthesizer, including known, related art, and/or later developed technologies to generate oscillating electrical signals.

In some other embodiments, the audio synthesizer 34 can be configured to generate electrical audio signals by using an analog circuit (not shown), digital algorithms, or waveform tables or samples stored in a database such as the database 28. The generated electrical audio signals may be influenced by the user preferences that maps to the musical parameters such as the pitch, amplitude, and so on, which may be continuously variable or is selected from a set of discrete parameters stored in the database 28.

In some embodiments, the audio synthesizer 34 can be a set of software instructions, or a firmware stored in the memory 14 and is executed by a processor such as the processor 12 of the electronic musical instrument 10. In some other embodiments, the audio synthesizer 34 can be a hardware that generates electrical audio signals. In some other embodiments, the audio synthesizer 34 can be a combination of a hardware or a software instructions that generates electrical audio signals.

In some embodiments, the audio synthesizer 34 can be configured to generate the acoustic sound compliant to the Musical Instrument Digital Interface (MIDI) standard. However, in some alternate embodiments, the audio synthesizer 34 can be configured to generate the acoustic sound compliant to some other standards such as open sound control. Embodiments are intended to include or otherwise cover any standards, including known, related art, and/or later developed technologies to enhance capabilities of the electronic musical instruments.

Further, a sound output unit 36 of the electronic musical instrument 10 can be configured to generate acoustic sound. The sound output unit 36 can generate the audio sounds by converting the oscillating electrical signals into acoustic sound. In some embodiments, the sound output unit 36 can be a speaker. In some embodiments, the sound output unit 36 may include, but not restricted to, an electroacoustic transducer. Embodiments are intended to include or otherwise cover any type of speaker, including known, related art, and/or later developed technologies to generate acoustic sound. In an exemplary embodiment, the speaker may include one or more amplifiers that convert the electrical analog sound into an actual acoustic pressure variation in the ambient medium.

In some embodiments, the sound output unit 36 can be configured to generate sound waveforms by sampling a table of the instantaneous amplitude values of the desired sound waveform. In an exemplary scenario, the sound waveform can be a simple sine function. In another exemplary scenario, the sound waveform can be a complex timbre composed of multiple sine components of different relative amplitudes. In the preferred embodiment, the instantaneous amplitude of the waveform is read from the table at a fixed sampling rate of, for example, 20,000 times per second and the pitch is controlled by skipping a number of table steps at each sample period. The larger the skip distance, the higher the resulting pitch.

In some embodiments, the sound output unit 36 can be an internal component of the electronic musical instrument 10 for generating acoustic sound. In some alternate embodiments, the sound output unit 36 can be externally connected to the electronic musical instrument 10. The internal/external sound output unit 36 may be connected to the electronic musical instrument 10 through a communication interface 37. The communication interface 37 may provide a simplex, half-duplex, or duplex communication between the sound output unit 36 and the electronic musical instrument. One sound output unit 36 shown in FIG. 2 is for illustration purpose. However, in alternate embodiments, the musical unit 16 can include more than one sound output unit 36.

In an exemplary embodiment, the processor 12 of the electronic musical instrument 10 gathers data from the attitude measurement unit 32 to control the musical parameters of the audio synthesizer 34 by executing the software instructions corresponding to the audio synthesizer 34. Further, the processor 10 may process the gathered data to take the necessary actions such as, but is not restricted to, to put the elements of the electronic musical device 10 into various modes of operation such as whether the audio synthesizer 34 is controlled in compliant to MIDI, whether to use an internal or external sound generating unit 36, and whether to use the attitude variables or their rates of change as the control parameters for the audio synthesizer 34.

### III. Operation of the Electronic Musical Instrument

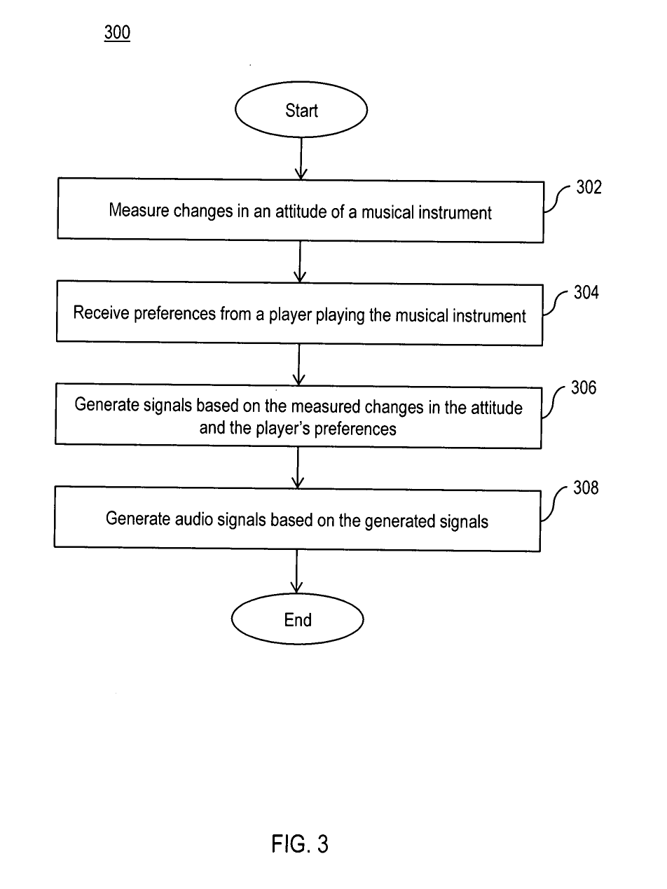

FIG. 3 is a flowchart of a procedure 300 for generating sound in accordance with the disclosed subject matter. This flowchart is merely provided for exemplary purposes, and embodiments are intended to include or otherwise cover any methods or procedures for generating audio signals.

In accordance with the flowchart of FIG. 3, at step 302, the electronic musical instrument 10 measures changes in its attitude. In an exemplary scenario, a player holds the electronic musical instrument 10 in his hand and starts moving the elbow in right and left directions, and the movement of the elbow leads to a change in the attitude of the electronic musical instrument 10. The attitude of the electronic musical instrument 10 can be, but not restricted to, a motion, an angle, a direction, a pitch, a roll, a yaw, and the like. In some embodiments, the change in attitude of the electronic musical instrument 10 can be measured by using motion sensors, such as, but not restricted to, accelerometers, gyroscopes, magnetometers, and the like. In some embodiments, the electronic musical instrument 10 can be configured to measure the change in attitude with respect to a reference frame in a multi-dimensional space.

At step 304, the electronic musical instrument 10 receives preferences from the player. The player preferences can include, but not restricted to, a musical scale, a name, a change in attitude mode, a rate of change in attitude mode, and the like. In the exemplary scenario, the player selects a change in attitude mode. In some embodiments, the player can provide the preferences by using the touch screen 20 of the electronic musical instrument 10.

Further, at step 306, the electronic musical instrument 10 generates signals based on the measured change in attitude of the electronic musical instrument 10 and the player's preferences. The generated signals are then used to control the musical parameters of the electronic musical instrument 10. As discussed, examples of the musical parameters can include, but not restricted to, pitch, amplitude, timbre, vibrato, tremolo, and the like.

Next, at step 308, the electronic musical instrument 10 generates audio signals based on the controlled musical parameters. In some embodiments, the electronic musical instrument 10 first generates electrical audio signals based on the signals generated by the electronic musical instrument 10. Then the generated electrical audio signals are converted to the acoustic sounds.

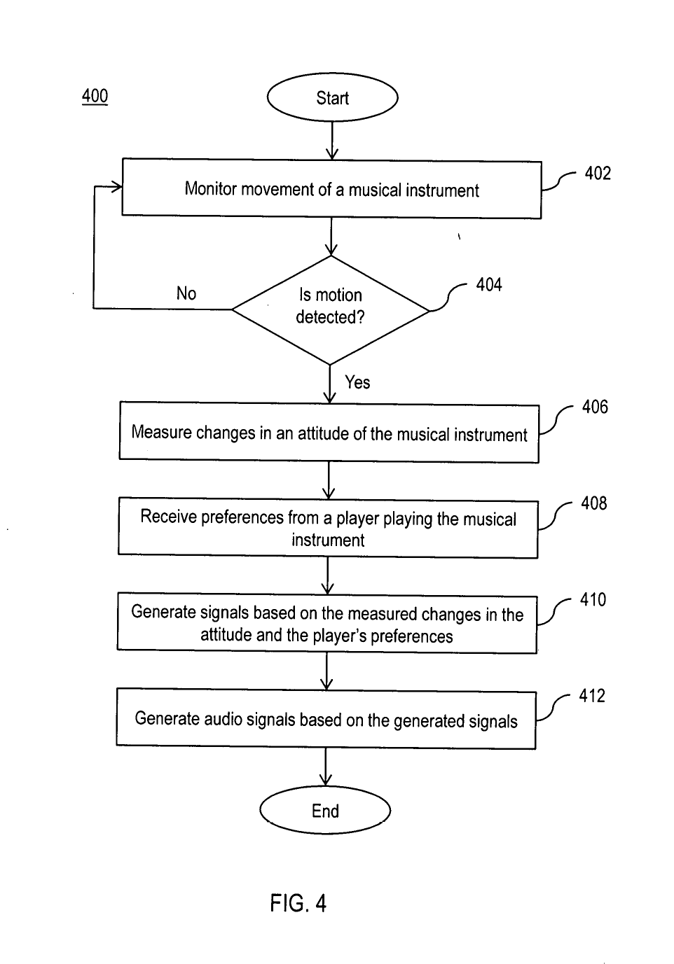

FIG. 4 is a flowchart of another procedure 400 for generating sound in accordance with the disclosed subject matter. This flowchart is merely provided for exemplary purposes, and embodiments are intended to include or otherwise cover any methods or procedures for generating audio signals.

At step 402, the electronic musical instrument 10 monitors movement of the electronic musical instrument 10. Then, at step 404, the electronic musical instrument 10 determines whether a motion is detected in the electronic musical instrument 10. In case the motion of the electronic musical instrument 10 is not detected, then the procedure 400 returns to the step 402 and continues monitoring the movement of the electronic musical instrument 10. In case, a motion is detected by the electronic musical instrument 10, then the procedure 400 proceeds towards a step 406.

At step 406, the electronic musical instrument 10 measures changes in its attitude. In an exemplary scenario, a player holds the electronic musical instrument 10 in his hand and starts moving the wrist in up and down directions, angular motion and the movement of the wrist leading to a change in the attitude of the electronic musical instrument 10. The attitude of the electronic musical instrument 10 can be, but not restricted to, a motion, an angle, a direction, a pitch, a roll, a yaw, and the like. In some embodiments, the change in attitude of the electronic musical instrument 10 can be measured by using motion sensors, such as, but not restricted to, accelerometers, gyroscopes, magnetometers, and the like. In some embodiments, the electronic musical instrument 10 can be configured to measure the change in attitude with respect to a reference frame in a multi-dimensional space.

At step 408, the electronic musical instrument 10 receives preferences from the player. The player preferences can include, but not restricted to, a musical scale, a name, a change in attitude mode, a rate of change in attitude mode, and the like. In the exemplary scenario, the player selects a rate of change in attitude mode. In some embodiments, the player can provide the preferences by using the touch screen 20 of the electronic musical instrument 10.

Next, at step 410, the electronic musical instrument 10 generates signals based on the measured rate of change in attitude of the electronic musical instrument 10 and the player's preferences. The generated signals are then used to control the musical parameters of the electronic musical instrument 10. As discussed, examples of the musical parameters can include, but not restricted to, pitch, amplitude, timbre, vibrato, tremolo, and the like.

Further, at step 412, the electronic musical instrument 10 generates audio signals based on the controlled musical parameters. In some embodiments, the electronic musical instrument 10 first generates electrical audio signals based on the signals generated by the electronic musical instrument 10. Then the generated electrical audio signals are converted to the acoustic sounds.

As a result, the movement of the electronic musical instrument 10 in the player's hand is measured and based on the movement of the electronic musical instrument 10, sounds are generated.

### IV. Exemplary Scenario

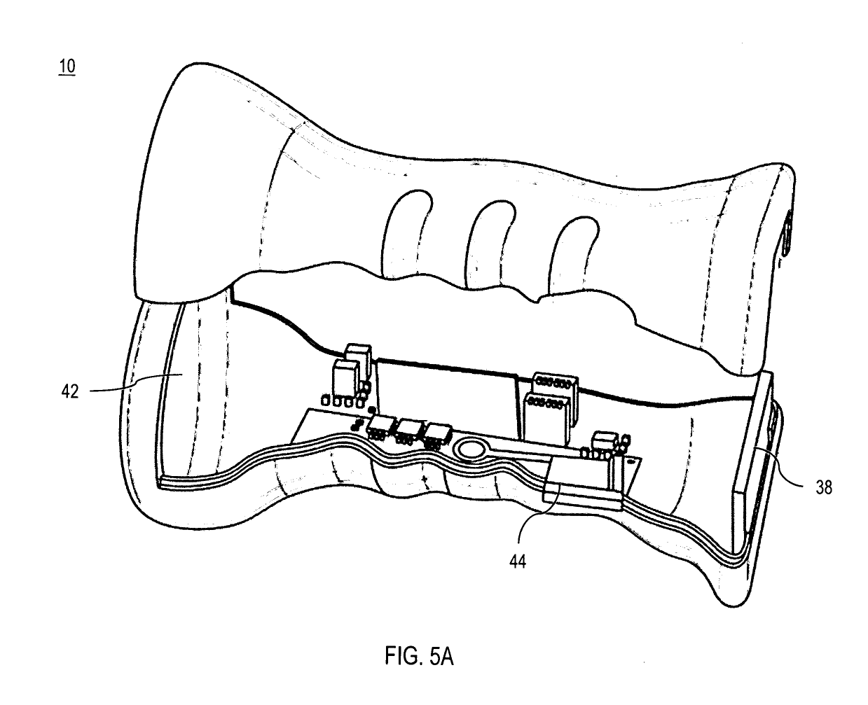

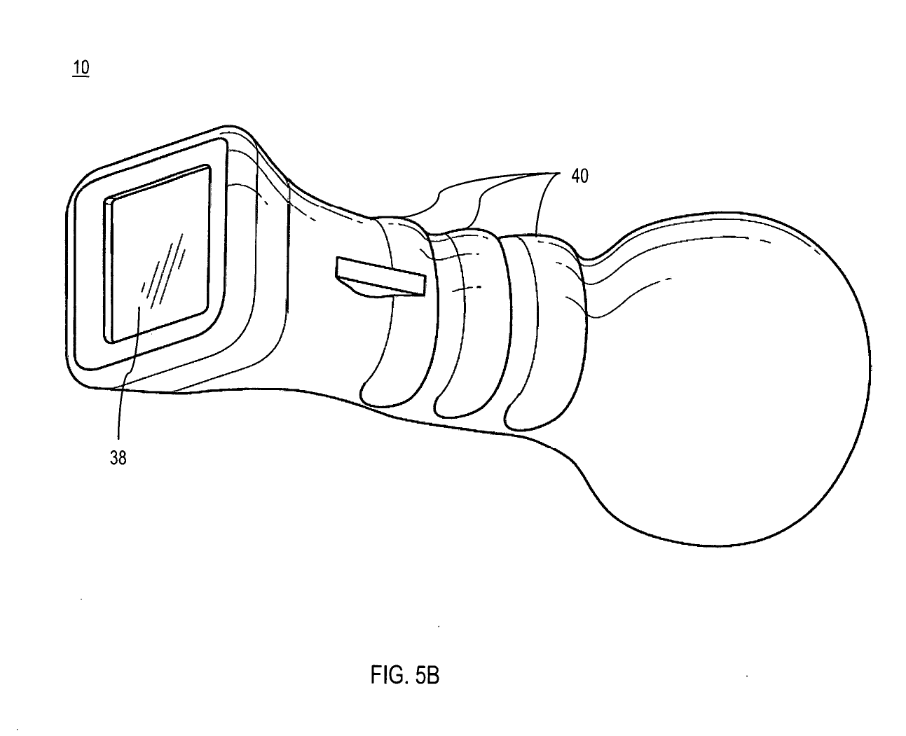

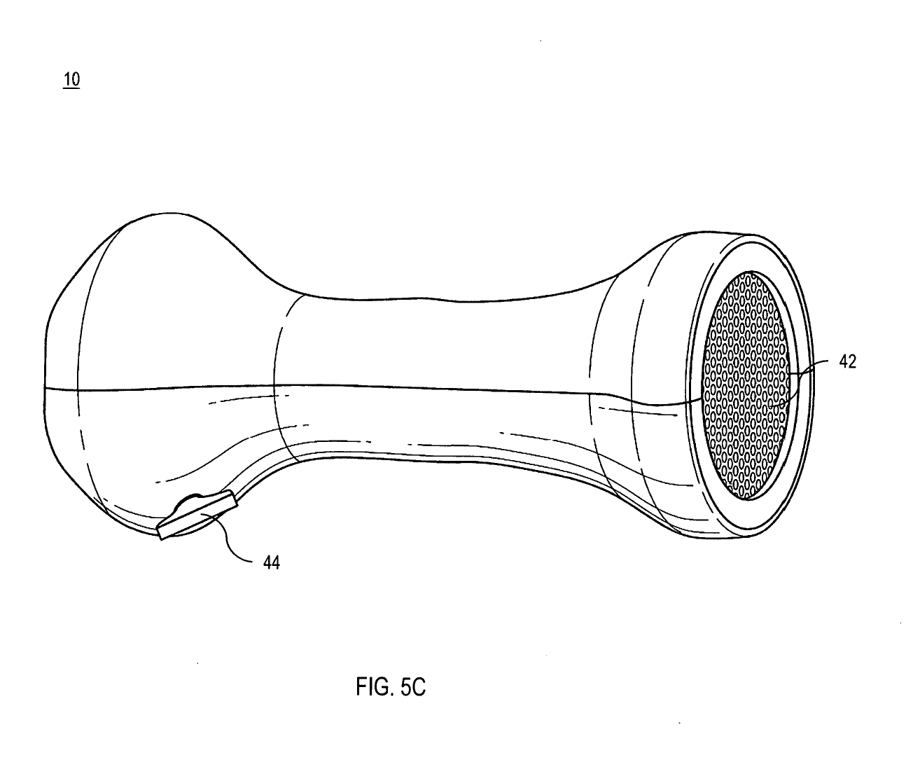

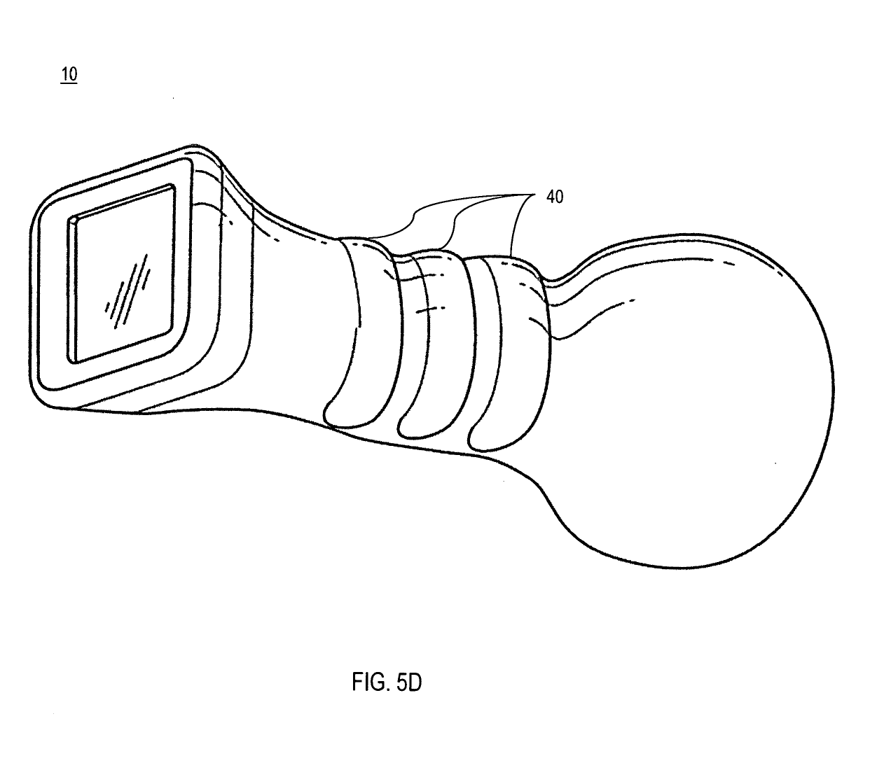

FIG. 5A illustrates an exploded view of the electronic musical instrument 10.

In some embodiments, the electronic musical instrument 10 can include a touch screen 38, such as the touch screen 20. The electronic musical instrument 10 further includes a speaker 42 in order to provide audio output to the player.

The electronic musical instrument 10 can also include a trigger 44 that can be used to alter the pitch of musical notes in the electronic musical instrument 10. In some embodiments, the trigger 44 can enable the player to adjust the musical tones while playing the electronic musical instrument 10 by using a two-state trigger response. The trigger 44 can be configured to change the state of the musical tone from one state to another state, for example, from the ‘rest’ state to a ‘up’ position. In some alternate embodiments, the trigger 44 can enable the player to adjust the musical tones while playing the electronic musical instrument 10 by using a continuously variable trigger response.

In some embodiments, the triggering state can be affected when the attitude of the electronic musical instrument 10 changes by the motion of the electronic musical instrument 10. However, other embodiments are intended to include or otherwise cover any type of trigger response that may be beneficial to trigger the electronic musical instrument 10. In some embodiments, the trigger 44 can be a push button. In some alternate embodiments, the trigger 44 can be a touch button. However, other embodiments are intended to include or otherwise cover any type of buttons that may be beneficial.

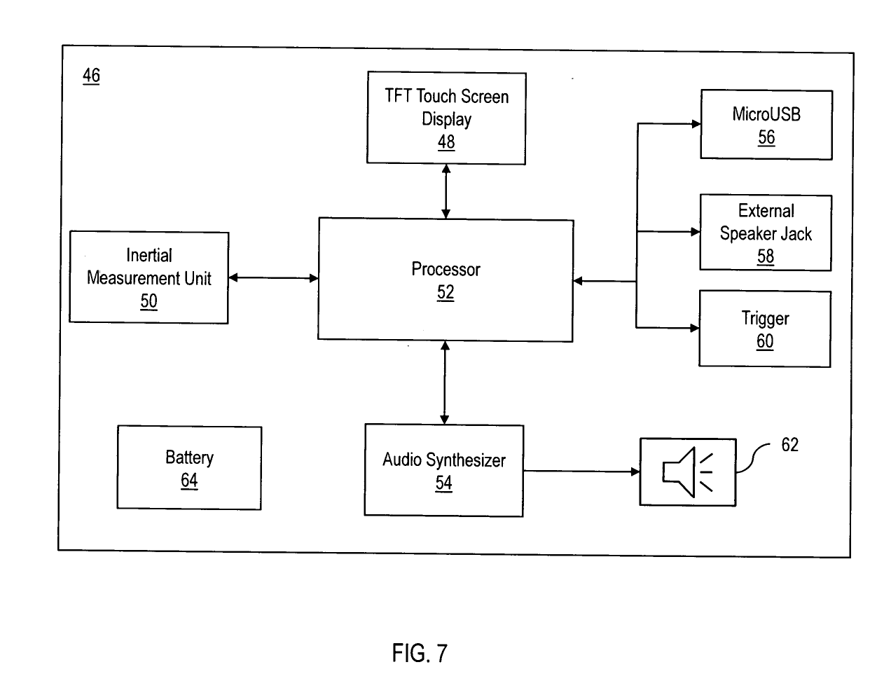

Further, the functioning of components of the electronic musical instrument 10 are described in detail below in conjunction with FIG. 7.

FIG. 5B illustrates a perspective view of the electronic musical instrument 10 in accordance with an embodiment of the present invention. The electronic musical instrument 10 can include a touch screen 38, such as the touch screen 20. The electronic musical instrument 10 can also include a hand grip 40 so that the player can easily hold the electronic musical instrument 10 in the hand. In some embodiments, the electronic musical instrument 10 can also include, but not restricted to, a microphone (not shown), in order to receive voice inputs from the player. In some alternate embodiments, the electronic musical instrument 10 can include, but not restricted to, a camera (not shown), in order to receive inputs based on the facial expression of the player. The facial expression and its associated input can be stored in the database 28 of the electronic musical instrument 10.

FIG. 5C illustrates a perspective view of the electronic musical instrument 10 in accordance with an embodiment of the present invention. The electronic musical instrument 10 further includes a speaker 42 in order to provide audio output to the player. FIG. 5D illustrates a side view of the electronic musical instrument 10 illustrating the hand grip 40 in accordance with an embodiment of the present invention.

In some embodiments, a power button (not shown) can be configured to switch-on and/or switch-off the electronic musical instrument 10. In some embodiments, the power button can be a push button. In some alternate embodiments, the power button can be a touch button. However, other embodiments are intended to include or otherwise cover any type of buttons that may be beneficial to power the electronic musical instrument 10.

In some embodiments, the dumbbell-shape of the electronic musical instrument 10 shown in FIGS. 5A-5C are for illustration purpose. However, other embodiments are intended to include or otherwise cover any shape, or structure of the electronic musical instrument 10.

In some embodiments, the electronic musical instrument 10 can be ten inches in height and five inches in width. However, other embodiments are intended to include or otherwise cover any size, or dimensions of the electronic musical instrument 10.

In some embodiments, the weight of the electronic musical instrument 10 can be in grams such as, 200 grams. However, other embodiments are intended to include or otherwise cover any weight of the electronic musical instrument 10 that may be beneficial for a player to hold the electronic musical instrument 10.

Further, embodiments are intended to include or otherwise cover any color of the electronic musical instrument 10.

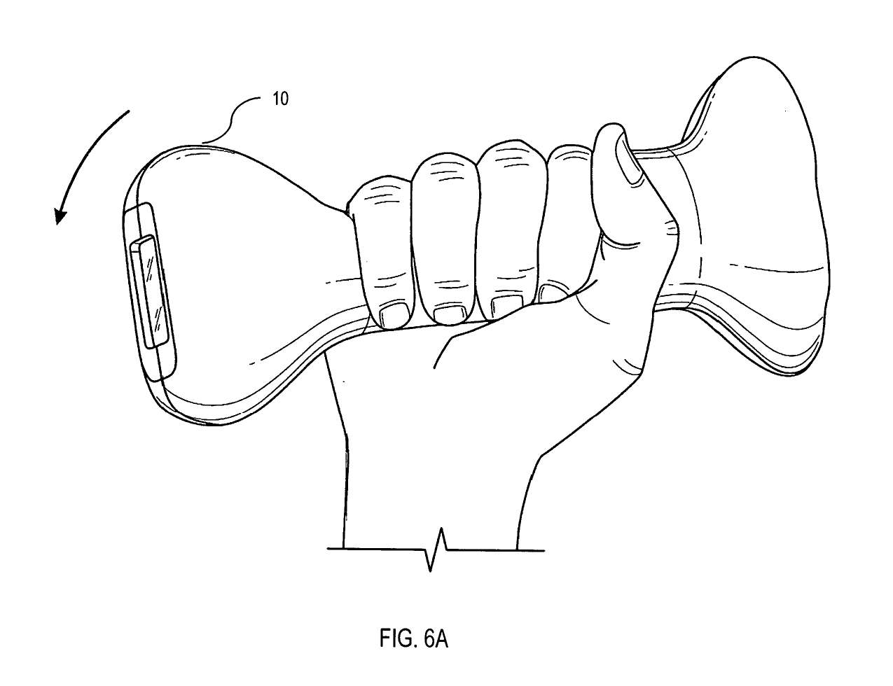

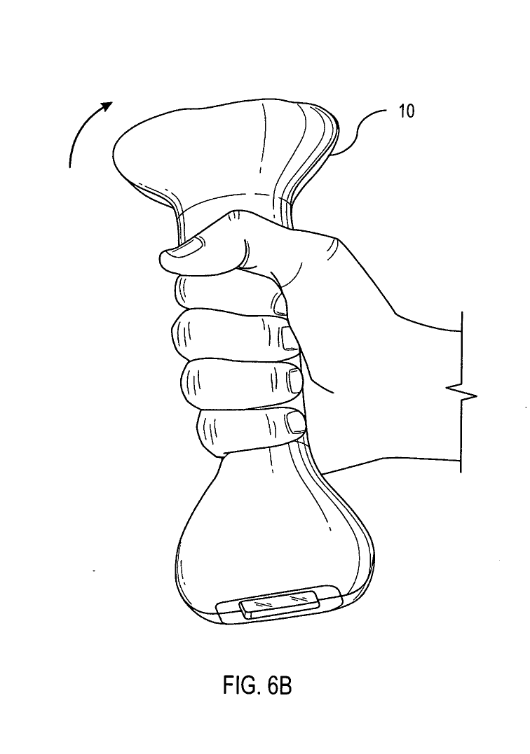

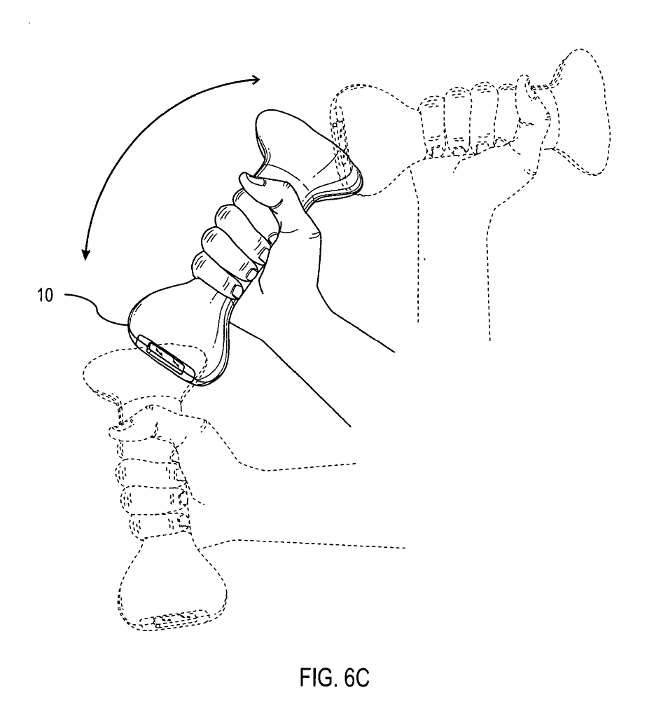

FIGS. 6A-6C are exemplary movement of the electronic musical instrument for generating sound.

FIG. 6A shows a player is holding the electronic musical instrument 10 in the hand and moves the electronic musical instrument 10 by moving the wrist. The player is moving the electronic musical instrument 10 in left and right directions. However, other embodiments are intended to include or otherwise cover motion of the electronic musical instrument 10 in any other direction. Also, in some alternate embodiments, the electronic musical instrument 10 can be moved by elbow, shoulder, and the like, of the player.

FIG. 6B shows that a player is holding the electronic musical instrument 10 in the hand and moves the electronic musical instrument 10 by moving the wrist. The player is moving the electronic musical instrument 10 in up and down directions. However, other embodiments are intended to include or otherwise cover motion of the electronic musical instrument 10 in any other direction.

FIG. 6C shows the movement of elbow of the player in up and down directions.

In some alternate embodiments, the electronic musical instrument 10 can be moved around principle axis in three dimensional space. The three dimensions may be, but not restricted to, a lateral axis (pitch), a vertical axis (yaw), and a longitudinal axis (roll).

In an exemplary scenario, as shown in FIG. 6C, a player holds the electronic musical instrument 10 in his hand by holding the hand grip and provides preferences such as, but not restricted to, a musical scale of ‘E flat Major’, and a rate of change in attitude mode by selecting one or more options from the touch screen 20 of the electronic musical instrument 10. The player then starts moving the elbow such that the electronic musical instrument 10 pivoted in the hand of the player also moves. Based on the motion of the electronic musical instrument 10, the attitude of the electronic musical instrument 10 changes. The changes in the attitude are detected by the motion sensors of the electronic musical instrument 10. Further, as per the player's preference, and the rate of change of attitude mode selected by the player, signals are generated. The signals are then used to control the musical parameters such as, the pitch, timbre, vibrato, and the like. The attitude of the electronic musical instrument 10 is controlled by multiplying a sample from a sound waveform table by an amplitude parameter from the measured attitude, scaled appropriately at a convenient range of angles, for example 0 to 90 degrees, of roll corresponding to the full dynamic amplitude range of the electronic musical instrument 10.

As the electronic musical instrument 10 moves, the attitude keeps on changing and signals are generated in accordance with the change in motion of the electronic musical instrument 10. Further, the signals are converted into acoustic sound for providing an audio output to the player.

### V. Implementation of Electronic Musical Instrument

FIG. 7 is a diagram of an exemplary electronic musical instrument 46 (e.g., a smartphone), which is capable of operating in the system of FIG. 1, in accordance with some of the embodiments of the disclosed subject matter. In some embodiments, the electronic musical instrument 46, or a portion thereof, constitutes a means for generating sounds.

Some embodiments of the electronic musical instrument 46 can include a Thin Film Transistor (TFT) touch screen display 48, an inertial measurement unit 50, a processor 52, an audio interface 54, and the like.

In some embodiments, the TFT touch screen display 48 can be used to register touch of a player using the electronic musical instrument 46. The player can register the preferences associated with the electronic musical instrument 46. The player's preferences can include, but not restricted to, a musical scale, a name, change in attitude, a rate of change of attitude, and the like.

Further, the inertial measurement unit 50 can be used to measure a change in attitude of the electronic musical instrument 46. The attitude of the electronic musical instrument 46 may include, but not restricted to, a motion, an angle, a direction, a pitch, a roll, a yaw, and the like. In an exemplary scenario, when a player holds the electronic musical instrument 46 in his hand and shakes the electronic musical instrument 10 left and right, and up and down, and the like, then the inertial measurement unit 50 measures the change in attitude and/or a rate of change of attitude of the electronic musical instrument 46.

The processor 52 can then further generate signals, by using algorithms, based on the player's preferences and the measured change in the attitude of the electronic musical instrument 46.

The audio synthesizer 54 can be used to generate audio signals based on the signals generated by the processor 52 of the electronic musical instrument 46.

In some embodiments, the audio synthesizer 54 is connected to a speaker 62 for generating audio sound based on musical parameters. The musical parameters are controlled by the signals generated by the processor 52. In some other embodiments, the audio synthesizer 54 may generate periodic electrical signals and then the sound output unit 36 (i.e. the speaker 62) transduces the periodic electrical signals to acoustic pressure signals, or sound. In some embodiments, the speaker 62 may receive power from a battery 64 or from a USB port 56. One speaker 62 shown in FIG. 7 is for illustration purpose. However, some alternate embodiments of the disclosed subject matter can include more than speaker in the electronic musical instrument 46. In some alternate embodiments, the electronic musical instrument 46 may include an external speaker jack 58 that may be used to connect an external speaker to the electronic musical instrument 46.

The battery 64 may be used to power components of the electronic musical instrument 46.

Further, in some embodiments, a trigger 60 of the electronic musical instrument 46 may be used to adjust musical parameters of the musical tone for generating sounds based on the motion of the electronic musical instrument 46 by the player.

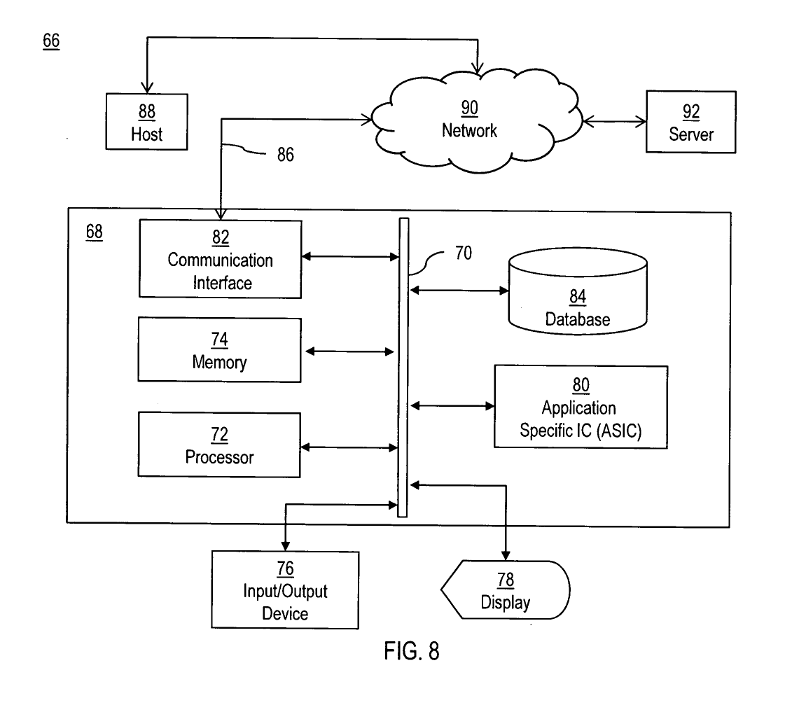

FIG. 8 illustrates an exemplary mobile system 66 upon which some embodiment of the disclosed subject matter can be implemented. The mobile system 66 may include a mobile device 68. In fact, embodiments of the disclosed subject matter are intended to include or otherwise cover any type of electronic device, including known, related art, and/or later developed technologies. The mobile device 68 can be programmed, for example, via computer program code or instructions to generate sounds described in the disclosed subject matter. The mobile device 68 can include a communication mechanism such as a bus 70 to pass data between internal and external components of the mobile system 66. The data can be represented as a physical expression of a measurable phenomenon, typically electric voltages, but can include, in some certain embodiments, such phenomena as magnetic, electromagnetic, pressure, chemical, biological, molecular, atomic, sub-atomic and quantum interactions. The mobile system 66, or a portion thereof, constitutes a means for performing one or more steps for generating sounds.

The bus 70 can include one or more parallel conductors of data so that the data can be transferred quickly among communication devices coupled to the bus 70. In some embodiments, a processor 72 is coupled with the bus 70 for processing the data. However, one processor 72 shown in FIG. 8 is for illustration purpose. However, some alternate embodiments of the disclosed subject matter can include more than one processor 72.

The processor 72 can perform a set of instructions on the data as specified by computer program code related to generate sounds. In some embodiments, the processor 72 can be implemented as mechanical, electrical, magnetic, optical, chemical, or quantum components, among others, alone or in combination.

The mobile device 68 can also include a memory 74. In certain embodiments, the memory 74 can be coupled to the bus 70. In some embodiments, the memory 74 can be, but not restricted to, a Random Access Memory (RAM), a Read only Memory (ROM) or any other dynamic or static storage device, stores information including processor instructions for storing data and instructions to be executed by the processor 72. In some embodiments, the memory 74 can include a volatile storage that can lose the data and instructions stored thereon when power is lost. In alternate embodiments, the memory 74 can include a non-volatile (persistent) storage device, such as a magnetic disk, a solid state disk, optical disk or flash card, for storing data, including instructions, that persists even when the mobile device 78 is turned off or otherwise loses power.

The mobile system 66 can include an external input device 76, such as a keyboard including alphanumeric keys operated by a human user, a microphone, a mouse, a joystick, a game pad, a stylus pen, a touch screen, a sensor, etc. for providing the data to the bus 70. In some embodiments, external devices can be coupled to the bus 70, can be used primarily for interacting with humans, can include a display 78. In certain embodiments, the display 78 can be, but not restricted to, a Cathode Ray Tube (CRT), a Liquid Crystal Display (LCD), a Light Emitting Diode (LED) display, an organic LED (OLED) display, an active matrix display, an Electrophoretic Display (EPD), a plasma screen, etc. Further, in some embodiments, the display 78 can be a touch-enabled display such as a capacitive screen or a resistive screen.

In some embodiments, special purpose hardware, such as an ASIC 80 can be coupled to the bus 70. The ASIC 80 can be configured to perform operations that cannot be performed by the processor 72 quickly enough for special purposes.

The mobile device 68 can also include a communication interface 82 coupled to the bus 70. The communication interface 82 can provide a one-way or two-way communication coupling to a variety of external devices, such as, but not restricted to, speakers, earphones, external disks, etc. In some embodiments, the communication interface 82 can be a parallel port. In alternate embodiments, the communication interface 82 can be a serial port. Embodiments are intended to include or otherwise cover any type of communication interface, including known, related art, and/or later developed technologies. However, some alternate embodiments of the disclosed subject matter can employ more than one communication interface 82.

The mobile device 68 may also include a database 84 for storing the data. In some other embodiments, the database 84 can be used to store preferences of a player playing the electronic musical instrument 10. Embodiments are intended to include or otherwise cover any type of database, including known, related art, and/or later developed technologies. However, some alternate embodiments of the disclosed subject matter can employ more than one database 84.

A network link 86 can provide communication data by using transmission media through one or more networks to other electronic devices that can use or process the data. In some embodiments, the host 88 connected to the network 90 can provide a service in response to the data received over the network 90. For example, a server 92 can host a process that can provide data implementing additional scales or timbres to augment the functionality of the electronic musical instrument 10.

### VI. Alternative Embodiments

While certain embodiments of the invention are described above, and FIGS. 1-8 disclose the best mode for practicing the various inventive aspects, it should be understood that the invention can be embodied and configured in many different ways without departing from the spirit and scope of the invention.

For example, embodiments are disclosed above in the context of an electronic musical instrument. However, embodiments are intended to include or otherwise cover any type of electronic musical instrument, including a smartphone, a tablet, etc. In fact, embodiments are intended to include or otherwise cover configurations of the electronic musical instrument that can be beneficial to generate sounds.

Embodiments are disclosed above in the context of generating audio signals. However, embodiments are intended to cover methods and apparatus for generating audio signals based on the motion of the electronic musical instrument.

Embodiments are disclosed above in the context of an electronic musical instrument for generating sound. Further, the disclosed electronic musical instrument can be used by any player for generating audio signals.

Embodiments are disclosed above in the context of an electronic musical instrument. However, embodiments are intended to cover methods and apparatus for generating audio signals based on the movement of the electronic musical instrument 10.

Embodiments are disclosed above in the context of an electronic musical instrument. However, embodiments are intended to cover methods and apparatus for generating audio signals based on the motion and/or movement of the player's gross hand position.

Embodiments are disclosed above in the context of an electronic musical instrument. However, embodiments are intended to cover methods and apparatus for generating mastery of signals, which do not require strings, membranes, keys, buttons, or switches.

Embodiments are also intended to include or otherwise cover methods of generating audio signals disclosed above. The methods of generating audio signals include or otherwise cover processors and computer programs implemented by processors used to design various elements of the electronic musical instrument disclosed above.

Embodiments are also intended to include or otherwise cover a complete stand-alone electronic musical instrument comprising: (a) a form which can be held in a performer's hand and manipulated by the wrist, elbow, and shoulder; (b) an attitude measuring means capable of discriminating fractions of an angle; (c) a waveform generation means; (d) a sound generating means such as an electroacoustic transducer.

Embodiments are also intended to include or otherwise cover a complete stand-alone electronic musical instrument comprising: attitude measuring means and a processor to interpret the signals therefrom and a connection compatible with an external synthesizer which then serves as the waveform generation means.

Embodiments are disclosed above in the context of a portable and/or hand-held electronic musical instrument for generating audio signals. Further, embodiments are disclosed above in the context of a stand-alone electronic musical instrument for generating audio signals.

Embodiments are disclosed above in the context of an application or a software program compatible with a third-party hardware, such as, a smartphone, that may include, but not restricted to, an attitude measurement unit, a sound output unit, a processor, and the like.

Embodiments are disclosed above in the context of motion sensors that may be beneficial to measure attitude, or a change in attitude of the electronic musical instrument at lateral axis, a vertical axis, and a longitudinal axis.

Exemplary embodiments are intended to cover all software or computer programs capable of enabling processors to implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations for generating sounds disclosed above.

While the subject matter has been described in detail with reference to exemplary embodiments thereof, it will be apparent to one skilled in the art that various changes can be made, and equivalents employed, without departing from the scope of the invention. All related art references discussed in the above Background section are hereby incorporated by reference in their entirety.

What is claimed is:

1. An electronic musical instrument for generating a plurality of audio signals, the electronic musical instrument comprising:
an attitude measuring unit that is configured to measure one or more changes in an attitude of the musical instrument with respect to a reference frame in a multi-dimensional space;
a processor that is configured to generate one or more signals based on the measured changes in the attitude of the musical instrument; and
an audio synthesizer that is configured to generate the plurality of audio signals based on the generated signals.

2. The electronic musical instrument of claim 1, wherein the generated signals are used to control one or more musical parameters.

3. The electronic musical instrument of claim 2, wherein the musical parameters are controlled based on rotation and flexion of the wrist, elbow, and shoulder of the player.

4. The electronic musical instrument of claim 1, further comprising an input unit that is configured to receive player preferences from a player.

5. The electronic musical instrument of claim 1, wherein the reference frame comprises one or more of a gravitational frame, an inertial frame, or a geomagnetic frame.

6. The electronic musical instrument of claim 1, wherein the attitude measuring unit comprises a plurality of sensors to measure the change in one or more attitude of the musical instrument.

7. The electronic musical instrument of claim 1, wherein the audio synthesizer is further configured to generate oscillating electrical signals based on the one or more controlled musical parameters.

8. The electronic musical instrument of claim 1, wherein the audio synthesizer generates the plurality of audio signals compliant to the Musical Instrument Digital Interface (MIDI) standard.

9. The electronic musical instrument of claim 1, further comprising an external sound output unit generates sound by converting the oscillating electrical signals into acoustic sound.

10. The electronic musical instrument of claim 9, wherein the sound output unit comprises at least one speaker to provide an audio output to the player, wherein the speaker receives the audio signals from the audio synthesizer.

11. The electronic musical instrument of claim 1, further comprises a hand grip to hold the musical instrument.

12. The electronic musical instrument of claim 1, wherein the electronic musical instrument is pivoted in a hand of the player.

13. A method for generating a plurality of audio signals, the method comprising:
measuring, by an attitude measuring unit, one or more changes in an attitude of the musical instrument with respect to a reference frame in a multi-dimensional space;
generating, by a processor, one or more signals based on the measured changes in the attitude of the musical instrument; and
generating, by an audio synthesizer, the plurality of audio signals based on the generated signals.

14. The method of claim 13, wherein the generated signals are used to control one or more musical parameters.

15. The method of claim 13, further comprising receiving, by an input unit, player preferences from a player.

16. The method of claim 13, further comprising generating oscillating electrical signals based on the one or more controlled musical parameters, wherein the musical parameters are controlled based on rotation and flexion of at least one of a wrist, an elbow, and shoulder of the player.

167. The method of claim 13, further comprising generating the plurality of audio signals by converting the oscillating electrical signals into acoustic sound.

18. The method of claim 13, wherein the plurality of audio signals are generated compliant to the Musical Instrument Digital Interface (MIDI) standard.

19. A system for interfacing with an external sound output unit to generate a plurality of audio signals, the system comprising:
an electronic musical instrument, wherein the musical instrument comprises:
an attitude measuring unit that is configured to measure one or more changes in an attitude of the musical instrument with respect to a reference frame in a multi-dimensional space;
an input unit that is configured to receive player preferences;
a processor that is configured to generate one or more signals based on the measured changes in the attitude of the musical instrument and the player preferences; and
an audio synthesizer that is configured to generate the plurality of audio signals based on the generated signals, wherein the plurality of generated audio signals are compliant to the Musical Instrument Digital Interface (MIDI) standard, and
a communication interface that is configured to communicate the plurality of audio signals to the external sound output unit.

20. The system of claim 19, further comprises a hand grip to hold the electronic musical instrument.

21. The system of claim 19, wherein the attitude measuring unit comprises a plurality of sensors to measure the change in one or more attitude of the electronic musical instrument.

22. The system of claim 17, wherein the musical parameters are controlled based on rotation and flexion of at least one of a wrist, an elbow, and shoulder of the player.
